(19) United States
(12) Patent Application Publication
(10) Pub. No.: US 2007/0297853 A1
(43) Pub. Date: Dec. 27, 2007

(54) METHOD OF ATTACHING AN ATTACHMENT PLATE TO AN ELONGATE MEMBER

(76) Inventor: Kenneth Sharp, Skarholmen (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/746,108

(22) Filed: May 9, 2007

Related U.S. Application Data
(60) Provisional application No. 60/805,664, filed on Jun. 23, 2006.

(51) Int. Cl. F16B 5/00

(52) U.S. Cl. 403/386

(57) ABSTRACT

The method is for attaching an attachment plate to an elongate member. An attachment plate (10) is provided that has a spiral shaped cutout forming a fastener (22). The fastener (22) is pulled out and away from a bottom surface (14) against a biasing force of the fastener (22). An elongate member (30) is inserted into the fastener (22) so that the elongate member (30) is captured between the fastener (22) and the bottom surface (14). An outer end (24) at least partially wrapped around the elongate member (30). An inner edge (32) of the fastener (22) bears against the elongate member (30).

### PRIOR APPLICATION

This US patent application claims priority from U.S. provisional patent application No. 60/805,664 filed 23 Jun. 2006.

### TECHNICAL FIELD

The present invention relates to a method of attaching an attachment plate to elongate members such as cables, flower stalks or similar items.

### BACKGROUND OF THE INVENTION

Signs, cards, card holders and plates with attachment arrangements are previously known. A couple of known attachment arrangements for a sign are for example the commonly used name badges used at exhibitions, conferences, courses and stores or similar applications. However, none of the previously known attachment arrangements are particularly suited for attachments to elongate members such as cords. Many users of electronic equipment such as computer systems and home entertainment systems find it increasingly difficult to conveniently identify the increasing number of cords that connect the devices to one another in such computer or home entertainment systems. In order to identify a particular cord, it is now often necessary to go through the cumbersome exercise of tracing the origin of the cord that often is mixed in with all other cords/wires that are bundled behind the computer/entertainment systems. There is a need for a device and method to better connect attachments to cords and other elongate members in order to better identify the cords. There is also a need for a more effective way of attaching attachment devices to elongate members.

### SUMMARY OF THE INVENTION

The method of the present invention provides a solution to the above-outlined problems. More particularly, the method is for attaching an attachment plate to an elongate member. An attachment plate is provided that has a spiral shaped cut-out forming a fastener. The fastener is pulled out and away from a bottom surface against a biasing force of the fastener. An elongate member is inserted into the fastener so that the elongate member is captured between the fastener and the bottom surface. An outer end at least partially wrapped around the elongate member. An inner edge of the fastener bears against the elongate member.

One object of the present invention is to provide a sign/plate with an attachment arrangement that at least partially eliminates the drawbacks that are associated with the arrangements of the prior art. An additional object is to provide a sign/plate with an attachment arrangement that is easy to attach to different types of items and can be produced at a low cost.

The object is achieved by an attachment plate of a flexible, bendable material adapted for attachment to cables, flower stalks or similar items according to the present invention.

The attachment plate of the present invention can be a name tag, a business card or a card in the form of a credit card or a similar item. An advantage with this solution according to the present invention is that the attachment arrangement is integrated into the attachment plate and that the attachment plate substantially extends only in the extension plane of the plate. An advantage of the present invention is thus that the attachment plate eliminates the need for applying a separate attachment mechanism to the plate. The attachment mechanism of the attachment plate is shaped so that it can be attached to items with varied shapes and dimensions such as a cable, flower stalk etc. Yet another advantage is that the attachment plate makes it possible to produce the plate at a low manufacturing cost.

Different areas of use of the attachment plate can include attachment to a glass such as wine glass, champagne glass etc. at, for example, arrangements with table placing. The attachment plate can be in the form of a card that is attached to a flower stalk and so on.

The attachment plate is of a flexible, bendable material such as plastics, metal, paper or cardboard.

### BRIEF DESCRIPTION OF THE DRAWINGS

The invention is now described in more detail with reference to the appended drawings and the invention is not to be interpreted to be limited to the drawings in which

FIG. 1 is a perspective top view of the attachment plate according to the present invention;

FIG. 2 is a perspective bottom view of the attachment plate;

FIG. 3 is another perspective bottom view of the attachment plate of the present invention;

FIG. 4 is a perspective side view of the attachment plate attached to an elongate member;

FIG. 5 is a perspective rear view of the attachment plate attached to the elongate member;

FIG. 6 is a top view of the attachment place attached to the elongate member;

FIG. 7 is an elevational top view of a first alternative embodiment of the attachment plate of the present invention; and

FIG. 8 is an elevational top view of a second alternative embodiment of the attachment plate of the present invention.

### DETAILED DESCRIPTION

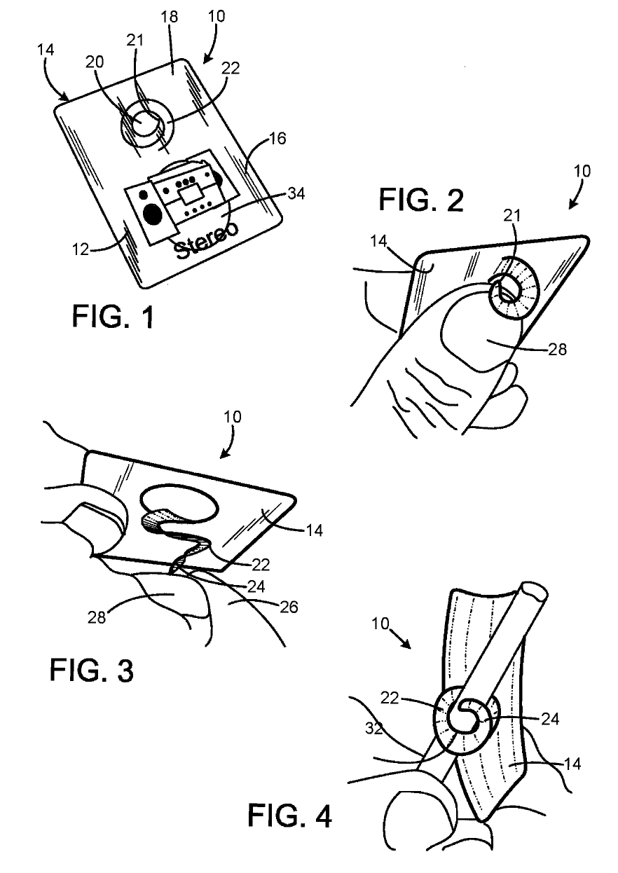

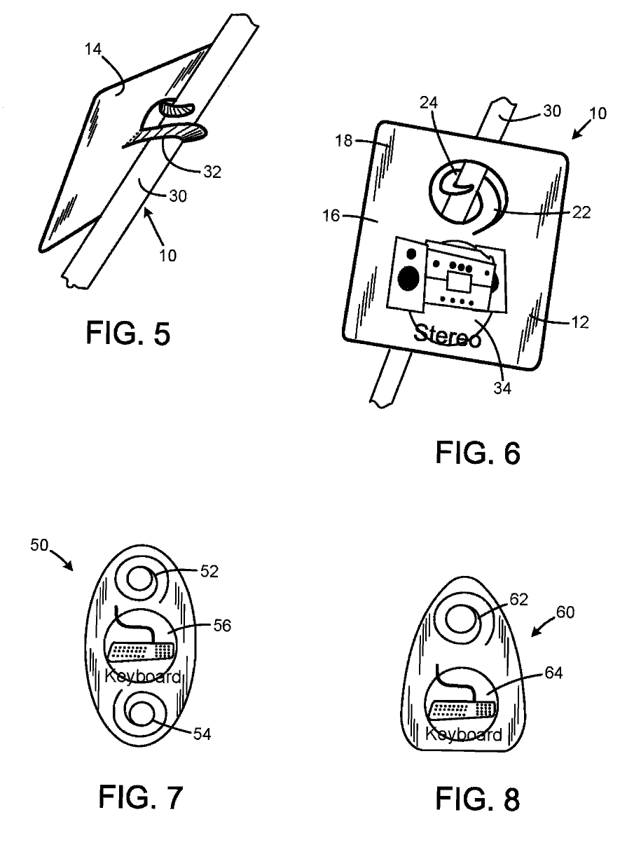

With reference to FIGS. 1-6, an attachment plate 10 has a top surface 12 and a bottom surface 14. The plate may be made of any suitable material such as plastics. The top surface 12 has an identification segment 16 and an attachment segment 18. The attachment segment 18 has an opening 20 around which a collapsed spiral shaped fastener 22 is cut out along a spiral shaped path in the plate 10. In this way, the fastener 22 may be a spiral shape cut out in the plate 10 so that an end tip 21 of the cut out terminates at the opening 20. In the collapsed position, as best shown in FIG. 1, the fastener 22 is flush with the top and bottom surfaces 12, 14.

As best shown in FIG. 3, the fastener 22 may be pulled away from the bottom surface 14 against a biasing force of the fastener 22 to form a helical shaped or spiral shaped fastener. For example, a user's fingers 26, 28 may be used to pull out the fastener 22 by grabbing an outer end 24 and then pulling out the fastener 22 so that the fastener 22 moves from a collapsed position, as shown in FIG. 1, to an expanded position, as shown in FIG. 3. The fastener 22 is resilient and is biased to go back from the expanded position to the collapsed position.

An elongate member 30, such as a cable, wire, flower stalk or any other elongate member, is placed between the expanded fastener 22 and the bottom surface 14 through the opening 22. The member 30 is thus urged towards the bottom surface. There is friction formed between the fastener 22 and the elongate member 30 when the outer end 24 is wrapped around the member 30. An inside edge 32 of the fastener 22 bears against the member 30 to further increase the friction between the member 30 and the fastener 22. Because the fastener is helical shaped, the inside edge 32 is rounded which is particularly suited to be attached around a round elongate member.

The identification segment 16 may also have identifying text or picture 34, such as the word stereo, to indicate that the cord is connected to the stereo. This is very useful behind a home entertainment center where there are a bundle of cords so the user can easily identify which cord is connected to certain electronic devices. It is to be understood that the attachment mechanism/plate of the present invention may be attached to any suitable object.

FIG. 7 is a top view of an alternative embodiment of an oval attachment plate 50 that has two spiral fasteners 52, 54 at each end and an identifying picture and text 56 therebetween. The plate 50 works the same as the plate 10 but it has two fasteners to further improve the attachment between the plate and an elongate member. In fact, the use of two fasteners substantially improves the attachment. The attachment plate 50 may also include an adhesive on one or both sides for removably mounting/organizing power cables thereto.

FIG. 8 is a top view of yet an alternative embodiment of a pear-shaped attachment plate 60 that has a spiral fastener 62 and an identifying picture and text 64.

In operation, the user pulls out the fastener 22 by pulling out the outer end 24. The outer end 24 is wrapped around the cord 30 when the cord is pulled through the opening 20 so that the inner edge 32 bears and holds the cord 30 so that the plate 10 does not slide along the cord 30. Also, the fastener 22 is biased towards the bottom surface of the plate so that the cord 30 is urged against the bottom surface 14 of the plate. This further improves the friction between the plate 10 and the cord 30 as the cord 30 extends parallel to the bottom surface 14 of the plate. Preferably, the plate 10 is turned so that the identifying text 34 is facing the user so that the user can easily see to what the cord is connected such as a stereo, television, CPU and printer. The plate 10 may easily be removed from the cord 30 by pulling out the fastener far enough so that the cord 30 may be removed between the outer end 24 and the bottom surface 14 of the plate.

The plate 10 of the present invention is very effective and firmly holds the plate to the cord. It is also relatively insensitive to the thickness or diameter of the cord since the fastener 22 is resilient and is wound around the cord. The plate 10 may not only be used to identify cord connections but also to attached messages on flowers and commercial messages on displays and shopping carts.

The plate is preferably produced by injection molding but any production method may be used.

While the present invention has been described in accordance with preferred compositions and embodiments, it is to be understood that certain substitutions and alterations may be made thereto without departing from the spirit and scope of the following claims.

1. A method of attaching an attachment plate, comprising:
providing an attachment plate (10) having a spiral shaped cut-out defined therein forming a fastener (22);
pulling out the fastener (22) away from a bottom surface (14) against a biasing force of the fastener (22);
inserting an elongate member (30) into the fastener (22) so that the elongate member (30) is captured between the fastener (22) and the bottom surface (14);
an outer end (24) at least partially wrapping around the elongate member (30); and
an inner edge (32) of the fastener (22) bearing against the elongate member (30).

2. The method according to claim 1 wherein the method further comprises the fastener (22) having an opening (20) defined therein and inserting the elongate member (30) through the opening (20).

3. The method according to claim 1 wherein the method further comprises expanding the fastener (22) from a collapsed position.

4. The method according to claim 1 wherein the method further comprises providing an identification segment (16) on the plate (10).

5. The method according to claim 4 wherein the method further comprises providing the identification segment (16) with a picture or text to identify the elongate member (30).

6. The method according to claim 1 wherein the method further comprises providing the plate (10) with a second fastener.

7. The method according to claim 1 wherein the method further comprises the elongate member (30) extending parallel to the bottom surface (14) of the plate (10).

8. The method according to claim 1 wherein the method further comprises the fastener (22) being flushed with both the bottom surface (14) and a top surface (12) of the plate (10) when in a collapsed position.

9. The method according to claim 1 wherein the method further comprises adding an adhesive to the plate (50) for mounting items thereon.
